(19) United States
(12) Patent Application Publication
(10) Pub. No.: US 2007/0073778 A1
(43) Pub. Date: Mar. 29, 2007

(54) Graphical, computer-based, project component management

(76) Inventor: Robert J. Simmons, Hayward, CA (US)

Correspondence Address: ROBERT D. VARITZ, P.C., 4915 SE 33RD PLACE, PORTLAND, OR, 97202, US

(21) Appl. No.: 11/527,281

(22) Filed: Sep. 25, 2006

Related U.S. Application Data
(60) Provisional application No. 60/721,935, filed on Sep. 28, 2005.

(51) Int. Cl. G06F 17/00

(52) U.S. Cl. 707/104.1

(57) ABSTRACT

A system, and an associated methodology implemented by that system, for project component management in a defined-phase, plural-interrelated-component project. The methodology includes (a) establishing, for each of selected project components, a component-specific, graphical representation which is presentable on a display screen, (b) with respect to a selected project phase wherein phase-relevant components experience a status change from a first status to a second status, tracking the relevant project-progress, such status changes experienced by such components, and (c) utilizing a computer which is made aware of the establishing and tracking steps, providing, on a display screen, and in a sequential manner, selected component status-change progress via presenting on that screen at least one of (1) phase-completeness-relevant, incremental, defined spatial additive-association presentation, and (2) phase-completeness-relevant, incremental, defined spatial subtractive-dissociation presentation, of the graphical representations of such components.

### CROSS REFERENCE TO RELATED APPLICATION

This application claims priority to currently copending, prior-filed U.S. Provisional Patent Application Ser. No. 60/721,935, filed Sep. 28, 2005, for “Graphical, Computer-Based, Project Component Management”. The entire disclosure content of this provisional application is hereby incorporated herein by reference.

### BACKGROUND OF THE INVENTION

This invention relates to the management, as will be explained, both from a systemic and from a methodologic point of view, of the making, transporting, storing, installing, etc., of plural, interrelated components which are to be employed as assembled components in a defined-phase project, such as a defined plural-phase structural building project. While, as will become apparent, the features of the invention have utility in a number of different arenas, including a project which may have only a defined single phase, a preferred and best mode embodiment of the invention is described herein in conjunction with what can be described as being a precision, defined-plural-phase, structural building project, with illustrations given specifically in relation to components which are fabricated and ultimately assembled into a precision building frame and associated structure in a known relationship with respect to one another. It should be understood that discussion of the present invention in the context of such a precision structure, and in the specific illustrative setting of a building-frame structure, is done only for illustrative purposes. The unique management system and methodology described in this particular illustrative setting should resonate well with those generally skilled in the arts of various kinds of project management. The term “defined-phase” used herein in relation to a project should be understood to mean either a single-phase or a plural-phase project.

Certain background documents mentioned immediately below describe an illustrative, building-frame-project setting for the practice of this invention. These documents—U.S. Pat. No. 6,837,016 B2, and U.S. Patent Application Publication No. 2005/0072108 A1—describe a structural building frame environment which involves, among other things, the project phases of component fabrication, preparation, delivery for on-site handling, and ultimate component assembly into a precision structural building frame made up of various and numerous components which can be assembled on a jobsite with great precision, and in a very efficient and relatively simple manner. The contents of these published documents are hereby incorporated herein by reference for background purposes.

### SUMMARY OF THE INVENTION

With respect to this background of the present invention, those skilled in the art clearly recognize that there is a need to have available, and to implement, sophisticated, accurate and intuitive management regarding the making, distributing, staging and assembling of the thousands of components which go into a major building structure. The present invention, accordingly, focuses attention for illustration purposes on a unique and highly intuitive methodology and a system for managing, in different phases of such a building-structure project, the fabrication, inventorying, delivering and staging, and the ultimately assembling of all, or of as many of all as desired, of such building-structure components parts. Specifically, the present invention offers a unique, computer-based graphical approach for providing project-component-part “flow-management”, and very specifically such management which is adaptable and useable at substantially all phases of a building-structure project.

According to practice of the invention, for each project component which is to be managed by implementation of the invention, a component-specific, electronically manipulable, virtual, three-dimensional, graphical representation, or element, is created, for example in a software database, for direct manipulation and management, including three-dimensional orientation adjustment, by a computer on the display screen in what is referred to herein as a display instrumentality, such as the display screen in a laptop or desktop computer. These representational elements may be either quite realistic in appearance (preferred in actual practice of the invention), or schematic and symbolic in appearance. In order to simplify the drawings herein, such graphical, representational elements are shown in these drawings only schematically and symbolically.

The database provided for, and containing, such graphical elements, or component representations, may be structured in such a fashion that components can be illustrated (i.e., shown on a display screen) from a variety of different angular points of view, in different scales, and in different image characters, such as line-quality characters, shading characters, color characters, etc. Preferably, each actual building component, as appropriate, is assigned (and bears) a specific, dedicated, identifying code number, such as a barcode number, a serial number, or an address, which, as appropriate, fully identifies the component and its intended location and orientation in a finally completed project. Actual components employed in the carrying out of the project may, either individually, or in the case of extremely small components, such as nuts and bolts, etc., in groups, be numbered in any other suitable fashion. Such barcode numbers are directly associated with the appropriate, respective, graphical elements “contained” in the mentioned database, and are linked to “computer knowledge” regarding part count and proper part placement in an intended building structure.

As those skilled in the art will recognize with respect to the management of a project like that generally set forth above, this kind of project is characterized by a number of stages, or phases, and it should be understood that the present invention and its practice can be implemented in any designated and selected stage of a project, as well as in all such stages. Accordingly, and as a first illustration of practice of the invention, that practice is herein specifically stated in the context of the early-stage project process of fabricating components, such as columns and beams, and connectors for use between columns and beams, to be employed in the assembly of a major, plural-story building frame.

There are many different ways in which a computer-based system for implementing this invention may be organized. For example, one might choose to use a single central computer or computing facility which contains all relevant data, and to which is/are connected a plurality of outlying computer work stations and display screens that are disposed at various sites where various stages of the building project are to be managed. The system of the invention could also just as easily be implemented by using a number of independent computers deployed at similar locations completely self-contained with respect to the relevant database(s) that is/are associated with the specific phase of work being managed at a particular work station, or workstations.

For example, one illustrative way of employing the invention could involve providing one or more management-control workstations which are equipped with one or more computers, and one or more display screens, on which computer-manipulated images of project phase-relevant components may be presented to a manager, for example, as they (these components) are completed in a manufacturing phase. Such component images (graphical representations) may be shown on a display screen in correct spatial relationship with respect to where they are to fit into their associated portion or region of a final building project, and they may be presented on a screen in a kind of phantom accompanying imagery which illustrates, for example, componentry which has not yet been completed, but is expected to be completed as a part of implementing a particular phase of a plural-phase project. This approach offered by the invention thus uniquely helps to identify any “missing”, phase-relevant components.

For example, with respect to components of a certain category, or of certain categories, that are to be assembled in a portion of a building structure, such a portion of that structure may be illustrated initially in phantom lines on a display screen, with these phantom lines being presented in a manner which effectively shows a composite assembly of all components which are to be completed during that particular project phase. As real components in their fabrication phase are completed, the respective, associated component phantom outlines may become highlighted, shaded, or in some other way presented in a changed and visually differentiating way, to represent fabrication completion, thus allowing managing personnel to view graphically the progress in the fabrication of required components for the associated project structural region related to a particular phase of a construction project.

Another illustrative approach could include a start-up display of a fully “assembled” image, or images, of a portion of a building project and its relevant components, with deconstruction, or dissociation, being used as a device for indicating the completion of fabrication of components for that portion of the project. Under such an approach, a managing party would initially view a fully assembled arrangement of relevant building components, which arrangement would incrementally “disappear” as fabrications of different components were completed—leaving “suspended” for viewing any unfinished components.

The imagery provided on a display screen in accordance with practice of the present invention can be presented, as has been suggested above, in a number of different ways, including in perspective views, in plan and elevation views, in phantom views, in isometric and/or exploded views, in positionally adjustable (moveable) views, etc., completely at the desire of a particular designer and user of a system which implements the present invention.

From what has just been generally described above with respect to “component fabrication” as one stage or phase for illustration of the management of a project utilizing the graphical display concepts of this invention, it will be apparent that the invention concepts are readily employable in a variety of different ways for different phases/stages in a project, such as for final building assembly, and for inventory build-up and staging for a project, as, for example, may be related to the delivery of components to a staging site for subsequent handling, etc. In any stage or phase where a “missing part” indication is important and useful, practice of the present invention conveniently, graphically and highly intuitively enables visualization of this missing part.

With respect to the nature of graphical representations of different phase-relevant building components, it should be clearly understood that such components may be shown in full representational manners, or in any variety of abstract or other-presentation manners.

As a way of thinking about, or visualizing, the practice of the present invention, particular stages or phases of a plural-stage building project can be imagined as being “throughput sites” or stations with respect to which there is an associated input side and an associated output side. On the input side of things components can be thought of as being in a first status, and on the output side those same components can be considered as being in a second status. With this visualization approach, components transform from their first status to their second status as they successfully “move through” the relevant project-phase throughput site. With this kind of visualization in mind, it is easy to understand how practice of the present invention can be implemented conveniently and successfully by project managers at a host of different progress points to be tracked along the entire implementation of a full building project.

The above features and operational advantages of the present invention will now become more fully apparent as the description which follows below is read in conjunction with the accompanying drawings.

### DESCRIPTION OF THE DRAWINGS

FIG. 1 is a high-level, block/schematic diagram of a graphical project management system constructed and operating in accordance with a preferred embodiment and manner of practicing the present invention.

FIGS. 2A, 2B and 2C are greatly simplified, block/schematic representations of three different specific kinds of work stations, or throughput sites, that further illustrate individual user-selectable workstations which may be invoked and employed in the overall systemic setting of the invention as illustrated in FIG. 1.

FIGS. 3A, 3B and 3C present high-level schematic illustrations fragmentarily illustrating three different phase-relevant building components, each of which is marked with a distinctive, stylized code, such as a barcode, which enables automatic reading and tracking of the handling of the associated component as it makes its way through different stations, or phases during a plural-phase construction project. Such barcode presence, and the reading thereof, may be employed in accordance with practice of the invention to trigger the operation of an appropriate controlling computer to add, or to subtract, a component display to or from the appropriate phase-relevant display screen.

FIG. 4 utilizes a vertical, schematic arrangement of main rectangular blocks, labeled A-H, inclusive, and within each of these main blocks, seven different sub-blocks. This imagery simplistically represents a given phase, or stage, in a plural-phase building project, with respect to which seven different components (the seven sub-blocks) are to be “handled” during the associated phase of the project. These seven components for this phase of the mentioned project are referred to as phase-relevant components. Two different, and oppositely directed, vertical arrows in FIG. 4 schematically represent different sequences of imagery presentation which can be used to describe component progress through the relevant building phase.

FIGS. 5-10, inclusive, present high-level, schematic illustrations of sequential, display-presented, graphical, throughput activities in a particular phase of a building project. As one progresses sequentially through these six drawing figures, from FIG. 5 through FIG. 10, one can observe that a dissociation, or disassembly, mode of presentation is being utilized to represent phase-relevant component “completion” in the particular, illustrated phase of a project. A reverse-direction progression through these same six drawing figures would represent an additive, or assembling, mode of presentation.

FIGS. 11-14, inclusive, are high-level, schematic illustrations describing different sequences of project phase completion in relation to a particular building phase, with several different manners of graphical screen display suggested in these drawing figures.

### DETAILED DESCRIPTION OF THE INVENTION

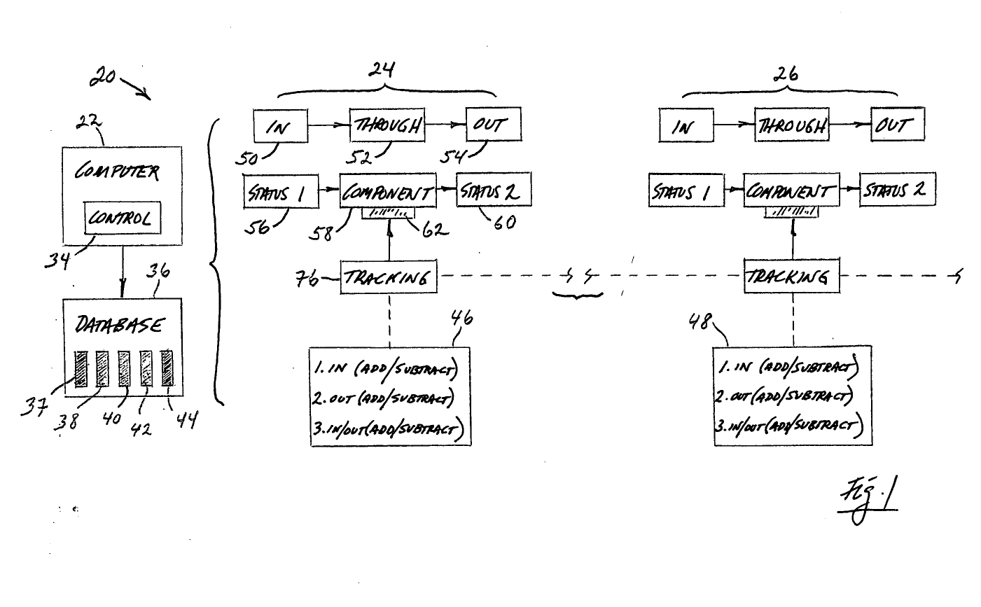

Turning now to the drawings, and referring first of all to FIGS. 1-3C, inclusive, indicated generally at 20 in FIG. 1 is a graphical, computer-based system for project management in what is referred to herein as a plural-interrelated-component, plural-phase (defined-phase or stage) project. Included in system 20 are a suitably programmed digital computer 22, and plural management-control workstations, or sites, such as the two such sites shown at 24, 26, which sites are suitably operatively and communicatively coupled to computer 22. Computer 22 acts as a central computer in system 20. Workstations 24, 26 are particularly associated with two, different, specific phases, or stages, of a plural-story building project as, for example, phases which involve two aspects the ultimate assembly of a plural-story structural building frame which is to be formed with columns, beams, moment connections connecting columns to beams, and related, additional hardware employed with respect to these several types of components.

With a digression for just a moment pointedly to FIGS. 2A, 2B and 2C, illustrated by blocks 28, 30, 32, respectively, in these three drawing views are three, high-level representations of workstations, such as previously mentioned workstations 24, 26, which relate each to a different specific phase of a building project. Block 28 in FIG. 2A relates to a stage of basic component fabrication from initial raw materials. Block 30 represents a workstation “project phase” associated with the reception, temporary storage and ultimate delivery of fabricated components which are to be incorporated in a finished building structural frame. Block 32 in FIG. 2C represents a project phase involving assembly of fully fabricated building components, such as columns and beams, etc., into the desired, ultimate structural building frame. The words “ADD” and “REMOVE” in blocks 28, 30, 32 generally illustrate a concept of the present invention which allows for user selection of different styles of graphical representation of “the passage” of a phase-relevant building component through the associated building phrase. The term “ADD” relates to a graphical representation, which will be more fully described shortly wherein as a building component passes from what is referred to herein as a “first status” to a “second status” through the relevant building phase, a graphical representation of that element becomes added to a graphical visual display which is presented on a display screen to a project phase manager. Similarly, the term “REMOVE” relates to another display methodology wherein graphical representations of first-status to second-status transformation of a building component is pictured by removal of a relevant component from a graphical display which is presented to a phase manager.

Returning to FIG. 1, and recalling that computer 22 is being illustrated herein as a central computer for the entirety of system 20, suitably associated with this computer, in relation to its proper programming for managing the system of the present invention is control software shown by a block 34. This control software, which may be entirely conventional in terms of its specific construction, is constructible well within the skill levels of persons generally skilled in the relevant art, and therefore, no details of this control software form any part of the present invention, or are specifically elaborated herein.

Additionally associated with computer 22 is an appropriately accessible graphical-representation database 36 which includes within it specific graphical representations, or elements, such as those shown by the five blocks labeled 37, 38, 40, 42, 44. It will be understood that these five blocks are intended to be representative of the entirety of all phase-relevant building components that are to be employed throughout the entire project of constructing a resulting structural building frame. As was mentioned earlier herein, these graphical, component-representational data elements, under the control of software 34 and computer 22, may be presented on graphical display screens, also referred to herein as display instrumentalities, such as the two such instrumentalities shown at 46, 48 in FIG. 1, associated herein specifically with workstations 24, 26, respectively.

As was mentioned earlier, under the control of computer 22, and with respect to each phase-relevant workstation, such as stations 24, 26, graphical component representations drawn from database 36 may be presented selectively by adding to, and/or by removing from, appropriate display images provided on display screens 46, 48 as their associated, phase-relevant building components “pass through”—i.e., transform from their first to second statuses relative to—the different, respective workstations. The various ways in which such building components may be represented on a display screen are numerous, and a number of these have been mentioned earlier herein. For example, and as a reminder, building components may be represented graphically by solid outlines, by phantom outlines, by colors or by surface shadings, and with any appropriate spatial angular orientations called for by a user, and implemented by computer 22, on a relevant display screen. Control software 34 enables such a wide palette of graphical component representations on the various workstation-specific display screens.

With respect to each of the two workstations, also referred to herein as throughput sites, 24, 26 in FIG. 1, several schematic blocks are presented in this figure to help illustrate structures and features that are relevant to these workstations. Thus, and referring specifically to workstation 24 which, as has already been mentioned, includes, or is associated with, a display screen 46, blocks 50, 52, 54 illustrate a way of visualizing station 24 as a throughput site (block 52), which site includes input and output sides—blocks 50, 54, respectively—all connected by “throughput arrows” extending between these blocks to represent a component-status-change transformation from what has been referred to herein as a first component status to a second component status as phase-relevant building components pass through station 24. Immediately below blocks 50, 52, 54 in FIG. 1 are blocks 56, 58, 60, with block 58 representing a specific phase-relevant component, and with blocks 56, 60, which are disposed on laterally opposite sides of block 58, representing the respective first and second statuses of component 58 as it passes through station 24.

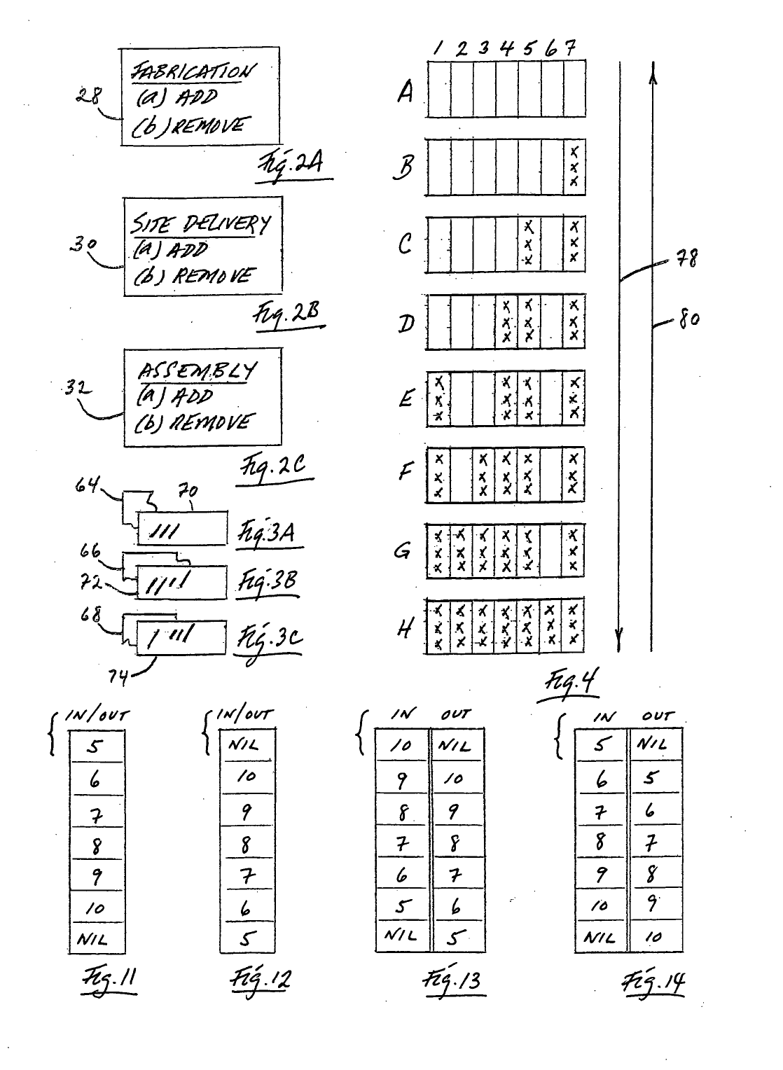

Looking specifically at FIGS. 1 and 3A, 3B, 3C in the drawings, shown as a pattern of angled lines in a small block 62 in FIG. 1, on the underside of block 58 in this figure, is a control code, such as a conventional barcode, which has been applied to, or which is otherwise directly and specifically associated with, component 58. In FIGS. 3A, 3B, 3C, three other, representative, phase-relevant building components associated with workstation, or project phase, 24 are shown by fragmentary blocks 64, 66, 68. These components (blocks) are associated specifically with three, different, barcode-like control codes represented by blocks 70, 72, 74, respectively.

In FIG. 1, a block 76, which is disposed immediately below block 58, represents appropriate tracking structure, such as conventional laser tracking structure, which is associated with workstation 24. Tracking structure 76 is enabled appropriately to read the control codes associated with the different phase-relevant components that pass through workstation 24, so as to enable computer 22 to “track” the first-to-second status-change transformations associated with components passing through station 24. Preferably, these control codes contain information not only specifically identifying each component, but also describing its intended location ultimately in a finished building structure, and also its intended spatial orientation in that structure. Such information, when provided to computer 22, enables the computer, under the control of software 34, to present on display screen 46, and to manipulate, the associated graphical representation for such a component drawn from database 36.

Completing a description of what appears in FIG. 1 in the drawings, and looking next specifically at textual information provided in this figure within display-screen block 46, several different component display modalities are suggested by this textual information. For example, the visual display associated with screen 46 may provide information effectively looking at the input-side (block 50; number 1 in block 46) statuses of things relevant to station 24, and may do so utilizing either an additive or a subtractive (Add/Subtract) mode for presenting a status change indication for a particular component on the associated display screen. Another mode of presentation might include graphical illustrations that relate to the output side (block 54; number 2 in block 46) of station 24, and again, in either an additive or a subtractive (Add/Subtract) manner of component-display representation. A third mode of presentation could include what might be thought of as a laterally split-screen display (blocks 50, 54; number 3 in block 46) which pictures both input and the output sides of station 24, with either an additive or a subtractive (Add/Subtract) approach employed on, say, the input side of the station, with the other (i.e., subtractive or additive) approach utilized to picture the output side of the station.

Workstation 26 on the right side of FIG. 1 is essentially the same as workstation 24, except that workstation 26 is associated with a project phase which is different from, and “downstream” relative to, workstation 24. Detailed numeric labeling is not, therefore, provided for workstation 26.

From what has been described so far herein, it will be apparent that a workflow manger associated, for example, with a single workstation, or site, like site 24, is provided with graphical information which vividly, intuitively and immediately provides a very clear graphical picture of project phase-relevant component “completion” in the associated project phase. Simply by looking at the display screen representations of phase-relevant components, such a manager can quickly observe and control proper completion of a particular project work phase.

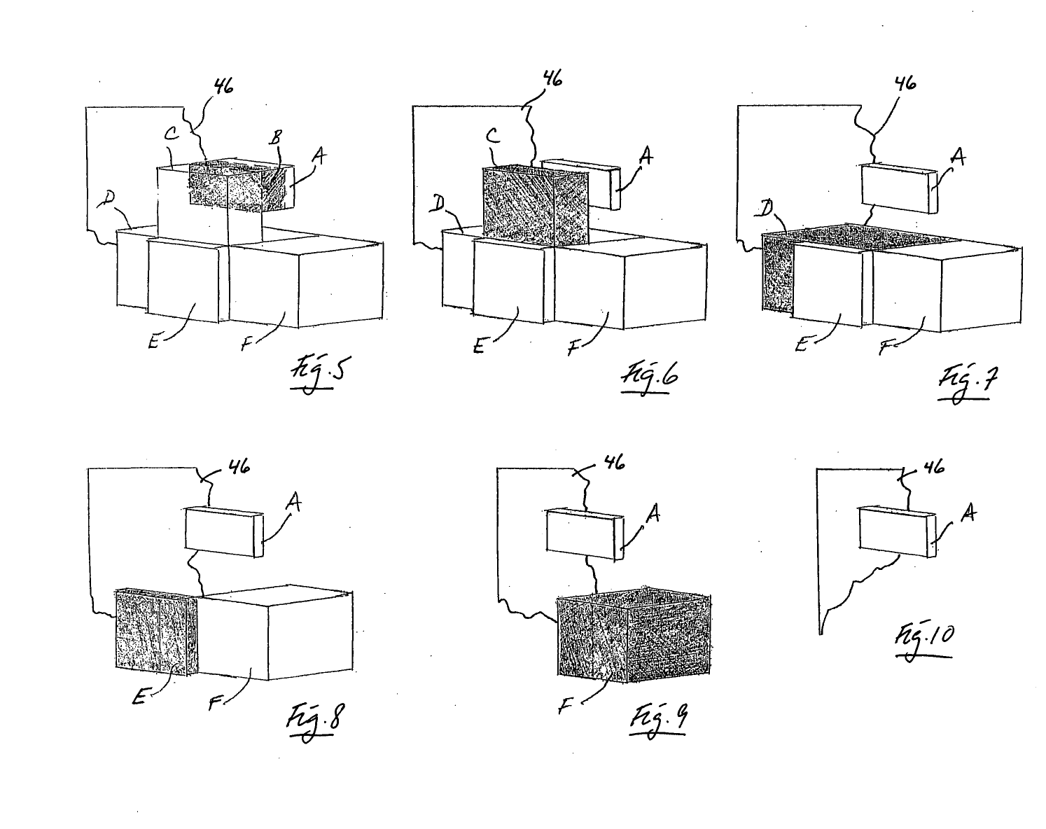

In different ways, FIGS. 4-14 in the drawings usefully illustrate different graphic display modalities employable in and by practice of the present invention.

In FIG. 4, for example, eight, major, vertically stacked blocks A-H, inclusive, are illustrated. These major blocks represent eight, different, sequential views which may be presented on a display screen in a sequence A-to-H, inclusive (see arrow 78), or in the reverse sequence H-to-A, inclusive (see arrow 80), in relation to a particular project phase. Within each of these blocks there are seven sub-blocks (1-7, inclusive) that represent seven, different, individual, phase-relevant building components which are associated with that project phase. An empty sub-block within each main block represents the absence of the appearance of the associated building component on the relevant display screen in relation to that main block. Cross marks presented in a sub-block within each main block represent the presence of the appearance of the associated building component on the relevant display screen in relation to that main block.

Accordingly, a screen-display sequence A-to-H, as defined by arrow 78, can be seen to be an additive sequence, wherein phase-relevant component graphical representations are successively placed in view as the associated component passes through the associated project phase. In contrast, a screen-display sequence H-to-A, as defined by arrow 80, can be viewed as a subtractive sequence, wherein phase-relevant component graphical representations are successively removed from view as the associated component passes through the associated project phase With attention directed now to FIGS. 5-10, inclusive, another way of describing and illustrating the present invention is shown. In these six figures, what is pictured (very schematically in block form) are six, stylized, schematic, successive screen displays that might be employed, in relation to a particular project phase, to illustrate the throughput, with respect to that phase, of six different (block-form) building components which are labeled with the capital letters A-F, inclusive.

If one imagines that FIGS. 5-10, inclusive, appear sequentially on a display screen in that order, one can see that a disassembly/dissociation (subtractive) mode of representation is being employed to illustrate successive and full completion of the pass-through of each six of these building components. A shaded block in certain ones of these figures represents the next component to be removed from the overall visual presentation as one “moves” to the next, sequential screen image.

If the order of graphic display presentation is reversed, beginning with what is shown in FIG. 10, and generally ending with what is shown in FIG. 5, one can see that such a sequence represents an additive manner of displaying the progress of the six, phase-relevant project components.

In all circumstances, any suitable, visual, representational style may be employed, at a user's selection, to show building components, including solid-outline representations, shaded block representations, suitably colored representations, etc.

Turning attention now to FIGS. 11-14, inclusive, in the drawings, and utilizing the drawing figure numbers associated with the specific, block-like, graphical, schematic/symbolic images which are presented in FIGS. 5-10, inclusive, and recognizing that these images might preferably take the forms of exact, pictorial component images in actual implementation of the invention, FIG. 11, when read with a downward progression through this figure, illustrates a subtractive mode of representing building phase progress viewed (entirely selectively by a user) either from the input side or the output side of the associated project phase. Similarly, FIG. 12 utilizes the same FIG. 5-10, inclusive, illustrations to represent an additive mode of phase completion activities, again viewed either from the input side or the output side of the relevant building phase. FIGS. 13 and 14 show two different ways wherein a split screen display might be provided representing building-component first and second statuses on the input and output sides of a project phase, viewed either additively or subtractively with respect to input/output phase sides.

Thus the invention features a graphical, computer-based system for project management in a plural-interrelated-component project having at least one project phase (defined phase) including (a) a digital computer, (b) a display instrumentality operatively connected to the computer, (c) a graphical database accessible by the computer, and containing, for each of selected project components which are relevant to the at least one project phase, and with the mentioned phase-relevant components being such that they experience a status change from a first status to a second status during the project phase, and have the characteristic that they are intended ultimately, in the project, to have a defined spatial relationship with respect to one another, a component-specific, electronically manipulable, graphical representation which is presentable on the display instrumentality under the control of the computer, (d) tracking structure operatively connected to the computer for tracking the status-change conditions of the phase-relevant project components, and (e) control software operatively linked to the computer to control the operation thereof with respect to the placing of tracking-derived information on the display instrumentality in the form of assembling or disassembling project-component graphical representations.

From a methodological point of view, the invention offers a graphical computer-based method for project component management in a plural-interrelated-component project including the steps of (a) establishing, for each of selected project components, a component-specific, electronically manipulable, graphical component representation which is presentable under computer control on a display instrumentality, (b) with respect to a selected project phase wherein phase-relevant components, which are intended, ultimately in the project, to have a defined spatial relationship with respect to one another, experience a status change from a first status to a second status, tracking the relevant project-progress, first-to-second status changes experienced by such components, and (c) utilizing a computer which is made aware of the establishing and tracking steps, providing, on a display instrumentality, and in a sequential manner, selected, project-phase, relevant-component, status-change progress via presenting on that instrumentality at least one of (1) phase-completeness-relevant, incremental, defined spatial additive-association presentation, and (2) phase-completeness-relevant, incremental, defined spatial subtractive-dissociation presentation, of the graphical representations of such components.

It will thus be apparent that the system and methodology of the present invention provide a unique and highly intuitive way for representing and controlling component project management throughout the various stages of a single-phase or plural-phase building project. The level of detail which may be included in graphical displays is purely a matter of user and designer choice, as is also the selected mode, or the selected modes, of additive and/or subtractive, input-side or output-side, graphical representations presented on a display screen. A manager working to control phase-relevant component progress through a given project phase may be enabled readily to manipulate imagery on a display screen so as clearly to picture work progress through a particular project phase. The presence or absence of a component in a selected display can immediately indicate to a project manager what has been completed in a particular project phase, and/or what needs still to be completed.

Thus, highly intuitive graphical imagery is employed to aid in the flow-management of a single-phase or plural-phase, and even quite complex, building project.

Accordingly, while a relatively large variety of preferred implementations of the system and methodology of the present invention have been described and illustrated herein, it is appreciated that other variations and modifications may be made by those generally skilled in the art without departing from the sprit of the invention.

I claim:

1. A graphical computer-based method for project component management in a plural-interrelated-component project comprising
establishing, for each of selected project components, a component-specific, electronically manipulable, graphical component representation which is presentable under computer control on a display instrumentality,
with respect to a selected project phase in a defined-phase project wherein phase-relevant components, which are intended, ultimately in the project, to have a defined spatial relationship with respect to one another, experience a status change from a first status to a second status, tracking the relevant project-progress, first-to-second status changes experienced by such components, and
utilizing a computer which is made aware of the establishing and tracking steps, providing, on a display instrumentality, and in a sequential manner, selected, project-phase, relevant-component, status-change progress via presenting on that instrumentality at least one of (a) phase-completeness-relevant, incremental, defined spatial additive-association presentation, and (b) phase-completeness-relevant, incremental, defined spatial subtractive-dissociation presentation, of the graphical representations of such components.

2. The method of claim 1 which further includes envisioning the selected project phase as being a status-change throughput station having an input side which is associated with the first status of a phase-relevant project component, and an output side which is associated with the second status of a phase-relevant project component, and said presenting includes selectively representing on the display instrumentality either the input side or the output side of the envisioned throughput station, with related placement on the display instrumentality, selectively, of either one of the mentioned defined spatial additive-association presentation or the mentioned defined spatial subtractive-dissociation presentation.

3. The method of claim 1 which further includes envisioning the selected project phase as being a status-change throughput station having an input side which is associated with the first status of a phase-relevant project component, and an output side which is associated with the second status of a phase-relevant project component, and said presenting involves representing on the display instrumentality both sides of the envisioned throughput station, and both types of the mentioned defined spatial additive and subtractive presentations.

4. The method of claim 1 which further comprises assigning and applying component-specific, machine-readable control codes to the phase-relevant project components, and operatively linking these assigned and applied control codes to respectively associated graphical component representations.

5. The method of claim 4, wherein the assigned and applied control codes contain information drawn from the list including (a) component identity, (b) component project location, and (c) component project orientation.

6. The method of claim 1, wherein said establishing of component representations includes preparing such representations to be display-presented as virtual, three-dimensional appearances which are orientable under computer control throughout a selected range of three-dimensional orientations.

7. A graphical, computer-based system for project management in a plural-interrelated-component project having at least one project phase comprising
a digital computer,
a display instrumentality operatively connected to said computer,
a graphical database accessible by said computer containing, for each of selected project components which are relevant to the at least one project phase, and with such phase-relevant components being such that they experience a status change from a first status to a second status during the project phase, and have the characteristic that they are intended ultimately, in the project, to have a defined spatial relationship with respect to one another, a component-specific, electronically manipulable, graphical representation which is presentable on said display instrumentality under the control of said computer,
tracking structure operatively connected to said computer for tracking the status-change conditions of the phase-relevant project components, and
control software operatively linked to said computer to control the operation thereof with respect to the placing of tracking-derived information on said display instrumentality in the form of assembling or disassembling project-component graphical representations.
